(19) United States
(12) Patent Application Publication
(10) Pub. No.: US 2009/0097524 A1
(43) Pub. Date: Apr. 16, 2009

(54) OPTICAL PUMPING DEVICE

(75) Inventors: Florent Thibault, Grenoble (FR); Denis Pelenc Denice, Quaix Chartreuse (FR)

Correspondence Address: Nixon Peabody LLP, 200 Page Mill Road, Palo Alto, CA, 94306, US

(73) Assignee: Commissariat A L'Energie Atomique, Paris (FR)

(21) Appl. No.: 11/920,174

(22) PCT Filed: May 5, 2006
(86) PCT No.: PCT/FR2006/050416

§ 371 Date: Nov. 8, 2007

(30) Foreign Application Priority Data
May 10, 2005 (FR) 0551187

(51) Int. Cl. H01S 3/091

(52) U.S. Cl. 372/70

(57) ABSTRACT

The invention relates to an optical pumping device (12). This device (12) comprises at least one thin layer (13) having a given volume, produced on an active material base doped with laser ions. The device (12) also comprises at least one pump beam (19) having a cross section of given dimensions, of a wavelength selected to be able to place the laser ions of the active material in an excited state. This pump beam (19) enters at an entry point (47) in the layer (13) with an angle of incidence (θp), forming at least one optical gain zone (20) in the layer (13). The zone (20) has a volume less than the volume of the layer (13) and a positioning in the layer (13) that are adjustable by means of the entry point (47), the dimensions of the cross section of the pump beam (19) and the angle of incidence (θp).

### FIELD OF THE INVENTION

The present invention relates to an optical pumping device. This device is particularly suitable for the amplification and/or guidance of a laser beam and for producing a laser oscillator. It may be used in any fields of application using laser light. In addition, the present invention also relates to a laser oscillator comprising this optical pumping device.

### STATE OF THE RELATED ART

A particle (atom, ion or molecule) in an excited state is liable to emit a first photon due to the stimulation caused by the arrival of a second photon of identical energy to the first photon. This phenomenon is referred to as stimulated emission. By repeating this phenomenon on several particles numerous times, a light consisting of all identical photons, of the same colour, emitted at the same time and in the same direction, referred to as a laser beam, is obtained.

In an active medium doped with laser ions, i.e. a medium consisting of numerous excitable particles, these particles are almost all, in the natural state, in a non-excited state. Therefore, it is necessary, by means of an energy source, to reverse this situation, i.e. obtain a greater number of particles in an excited state than in a non-excited stated, in order to be able to induce emission of a laser beam as described above. This process is referred to as “population inversion”.

Optical pumping is a population inversion method consisting of changing particles from their non-excited state to an excited state by making them each absorb a photon. Optical pumping may be used during the creation of a laser beam, i.e. to reverse the population in an active medium found in a laser oscillator, or to amplify and/or guide an existing laser beam, for example emitted by a laser diode, by making it pass through an active medium of an optical pumping device. In practice, optical pumping consists of sending one or more light beams, referred to as pump beams, in the active medium, in turn passed through by a beam emitted by a laser source, referred to as a laser signal beam.

Several optical pumping devices by laser diodes, comprising a planar geometry guiding structures, are known.

A transverse optical pumping device 1 is represented in FIG. 1A. A laser signal beam 2 passes through an active medium 4 doped with laser ions, by entering via a first face 6 of the active medium 4. One or more pump beams 3 also pass through the entire volume of the active medium 4, at right angles with the laser signal beam 2, by entering via a second face 5, at right angles with the first face 6, of the active medium 4. To carry out power amplification, this transverse optical pumping device 1 displays two major drawbacks. Firstly, given that the laser signal beam 2 and the pump beams 3 each enter the active medium 4 via a different face of the active medium 4, it is necessary to focus these beams 2 and 3 on their respective entry face 6 and 5. In addition, in view of the significant length of the trajectory of the pump beams 3 in the active medium 4, only low laser ion doping may be used in this active medium 4, so that the pump beams 3 are not entirely absorbed in the first millimetres of their trajectory. A third drawback of said transverse optical pumping device 1 is the low overlap between the laser signal beam 2 and the pump beams 3. This small overlap conveys the fact that part of the energy supplied in the active medium 4 by the pump beams 3 is outside the trajectory of the laser signal beam 2, given that the pump beams 3 pass through the entire volume of the active medium 4. This loss of energy results in an overheating of the active medium 4, a reduction in the yield, the appearance of parasite laser beams, and the deterioration of the quality of the laser signal beam 2.

A longitudinal optical pumping device 11 is represented in FIG. 1B. This device 11 differs from the transverse optical pumping device 1 in FIG. 1A in that a pump beam 3 passes through an active medium 4 doped with laser ions longitudinally with respect to a laser signal beam 2. The laser signal beam 2 and the pump beam 3 enter the active medium 4 via the same face 6 of the active medium 4. In addition to having the same drawbacks as the transverse optical pumping device 1 for power amplification, the laser signal beam 2 and the pump beam 3 must be colinear before entering the active medium 4. However, rendering beams from laser diodes, for example, which may be very asymmetrical, colinear requires a complex embodiment. However, with this longitudinal optical pumping device 11, the overlap between the laser signal beam 2 and the pump beam 3 is better than for the transverse optical pumping device 1.

An optical pumping device via a top face 10 is described in the document “Face pumping of thin, solid-state slab lasers with laser diodes”, Optics letters Vol. 21, No. 8, published on 15 Apr. 1996 and is represented in FIG. 1C. This optical pumping device 10 comprises a laser diode matrix 7 to emit pump beams (not shown in FIG. 1C), a micrometric aperture mirror 8, an active medium 4 and a resonant cavity 9. The method implemented by this optical pumping device 10, used for high power lasers, differs from the above two devices 1 and 11 in that the pump beams, from the laser diode matrix 7, pass through the apertures of the mirror 8 and enter via the top face of the active medium 4, perpendicularly to a laser signal beam 2. The pump beams are then reflected into the resonant cavity 9 by pumping the entire volume of the active medium 4 optically. The micrometric apertures of the mirror 8 make it possible to confine pump beams which are then dispersed throughout the resonant cavity 9. The major drawback of such an optical pumping device 10 is that it is expensive and complex. Although this method makes it possible to achieve high energy densities throughout the volume of the active medium 4, the overlap remains small. In fact, a considerable amount of energy supplied by the pump beams is lost in the active medium 4 and the resonant cavity 9, inducing the same drawbacks as those described above (overheating, parasite laser beams, etc.). In addition, given that the pump beams pass through the entire volume of the active medium 4, the laser signal beam 2 passes through the entire volume of the active medium 4 and a considerably multimode laser signal beam 2 is obtained at the output of the optical pumping device 10, even if, at the input, the laser signal beam 2 was, for example, monomode.

The document U.S. Pat. No. 5,485,482 discloses an optical pumping device. This device comprises a thick layer of active material, doped to a low level with Neodymium ions. This device is intended to perform monomode amplification of a laser signal beam. However, this operation may only be obtained by means of specific optimisation of the geometry of the optical gain zone and/or doping of the active material layer.

### DESCRIPTION OF THE INVENTION

The aim of the present invention is to propose an optical pumping device which does not involve the drawbacks of the prior art, i.e. having a short pump beam trajectory in an active medium, a large overlap between the pump beam and a laser signal beam not requiring colinearity between both beams, which is simple and inexpensive, and which makes it possible to obtain amplification of the laser signal beam by optimising the pump output density in the active medium, and carry out a laser signal beam guidance function. An aim of the present invention is also to produce an optical pumping device without significant constraints on the geometry of the optical gain zone and the doping of the active material layer.

In order to achieve this aim, the present invention proposes an optical pumping device comprising at least one layer having a given volume, the layer being produced with an active material base doped with laser ions, and at least one pump beam having a cross section of given dimensions, of selected wavelength to be able to place laser ions from the active material in an excited state, entering at an entry point in the layer with a given angle of incidence, forming at least one optical gain zone in the layer. The present invention also relates to an optical pumping device comprising at least one layer having a given volume, the layer being produced from an active material base doped with laser ions, and means to emit at least one pump beam having a cross section of given dimensions, of selected wavelength to be able to place laser ions from the active material in an excited state, said means being arranged such that the pump beam enters at an entry point the layer with a given angle of incidence, forming at least one optical gain zone in the layer. The optical gain zone has an adjustable volume and positioning in the layer by means of the entry point, to the dimensions of the cross section of the pump beam and the angle of incidence, the volume of the optical gain zone being less than the volume of the layer. The active material layer may be a thin layer.

In this way, instead of using an optical pumping device in which the pump energy is distributed throughout the active material layer, a device is used which concentrates the pump energy in a specific volume, thus making it possible to maximise the pump output density and therefore optimise the available gain. This restricted optical gain zone, adjustable in volume and in position by the pump beam characteristics, also makes it possible to perform guiding via the laser signal beam gain as the latter is preferentially propagated in the higher gain zones, in this case, the optical gain zone.

The thin layer may have a thickness between approximately 1 micrometer and a few dozen micrometers, and/or between approximately 1 micrometer and 10 micrometers, and/or less than approximately 100 micrometers, and/or less than approximately 50 micrometers. In this way, it is possible to perform monomode guiding of the laser signal beam.

The thin layer may be doped with a doping level of approximately 40% laser ions, and/or greater than approximately 30% laser ions, and/or greater than approximately 20% laser ions. Such doping makes it possible to maintain a good level of absorption of the pump beam in the optical gain zone, notwithstanding a small thickness of the active material layer, thus reducing the specific optimisation constraints on the geometry of the optical gain zone.

It is preferential for the laser ions to be ytterbium ions. These ions, of a simple electronic structure, make it possible to prevent parasite effects appearing in high power density optical pumping devices such as that according to the present invention.

The layer may be monocrystalline.

The layer may be based on yttrium orthosilicate or any other matrix displaying a reception site for laser ions.

It may be envisaged that the pump beam is emitted by at least one light source, such as at least one laser diode.

The pump beam may be shaped by at least one optical means, such as lens or a prism, before entering the layer so as to delimit the pump beam. The fact that this shaping is performed outside the layer allows considerable flexibility on the choice of light source and/or optical means used.

As the optical pumping device according to the present invention is designed to cooperate with at least one laser signal beam, the optical gain zone may defined in the layer, for the laser signal beam, a rectilinear trajectory or not.

As the optical pumping device according to the present invention is designed to cooperate with at least one monomode laser signal beam, the dimensions of a cross section of the optical gain zone may be approximately equal to those of a cross section of the laser signal beam, such that the laser signal beam remains substantially in a fundamental mode after passing through the layer. This makes it possible to simultaneously amplify the monomode laser signal beam and retain the modality of the beam.

It may be envisaged that the layer is arranged on at least one substrate. This substrate makes it possible to evacuate the heat forming in the thin layer in view of the confinement of the energy in the thin layer.

In this case, the substrate is preferentially made of a material transparent to the pump beam wavelength. This makes it possible to prevent energy losses from the pump beam in the substrate.

The index of the substrate material may be less than or equal to the index of the material in the layer, so that the laser signal beam remains confined in the layer.

The pump beam may pass through the substrate before entering the layer.

It is preferable for the substrate to comprise at least one bevel. This bevel enables the pump beam to enter the substrate by limiting the possible reflections on the substrate.

In this case, it may be envisaged that the pump beam enters the substrate via the bevel and passes through the substrate before entering the layer.

Preferentially, the optical pumping device, according to the present invention, comprises at least one superstrate arranged on the layer. This superstrate may in particular serve to handle the harmful thermal effects on the optical pumping device and minimise diffusion losses during the propagation of the laser signal beam.

The index of the superstrate material may be less than or equal to the index of the layer material, in order to confine the laser signal beam in the layer.

The superstrate may be made of material transparent to the pump beam wavelength, so that there are no energy losses in the superstrate.

It may be envisaged that the pump beam passes through the superstrate before entering the layer.

The superstrate may be made of a material absorbent to the pump beam wavelength. In this way, after the pump beam has passed through the layer, all the residual intensity of the pump beam which has not been absorbed in the layer is absorbed in the superstrate.

The optical pumping device according to the present invention may comprise at least one reflective face facing the layer.

In this case, the pump beam may be reflected on the reflective face and form in the layer at least a second distinct optical gain zone from the optical gain zone, the second optical gain zone being separated or practically attached to the optical gain zone.

In another alternative embodiment, the pump beam may be reflected on the reflective face and form at least one second optical gain zone overlapping with the optical gain zone, thus creating a single optical gain zone.

It may be envisaged that several pump beams intersect in the layer such that the pump beams cooperate to form the optical gain zone. In this case, the optical gain zone is more complex than in the previous cases and may make it possible to amplify a given laser signal beam mode more specifically.

The pump beams may have different wavelengths to avoid saturating a given laser signal beam absorption line.

It is also possible to envisage that at least two pump beams, from a common light source, each having an angle of incidence on the layer, interfere in the layer such that the optical gain zone formed by the two pump beams have a pump output density varying in a sinusoidal manner.

The optical gain zone may also be divided into at least two first parts separated from each other by at least one non-illuminated zone of the layer, and into at least one common second part connecting the first two parts.

The volume of the layer may be delimited by a first and second substantially plane main faces. These faces may also be substantially parallel.

The present invention also relates to a laser oscillator, designed to create a laser beam, comprising at least two mirrors and an optical pumping device, also according to the present invention. The two mirrors are attached or not to the optical pumping device, one of the two mirrors being designed to return the laser beam in the optical gain zone, and the other of the two mirrors being designed to return part of the laser beam in the optical gain zone and allow another part to pass outside the optical pumping device, such that the optical pumping device is a gain module of the laser oscillator.

The volume of the optical pumping device layer may be delimited by a first and a second substantially plane and parallel main first and second face, one of the two mirrors having a reflective face arranged against a third face of the layer, substantially perpendicular to the two main faces, and the other of the two mirrors being a semi-transparent mirror, substantially parallel to the first mirror and arranged against a fourth face, opposite the third face, of the layer.

### BRIEF DESCRIPTION OF FIGURES

The present invention will be understood more clearly on reading the description of examples of embodiments given for purely indicative and non-limitative purposes, with reference to the appended figures wherein:

FIG. 1A, already described, is a perspective view of an example of a transverse optical pumping device according to the prior art,

FIG. 1B, already described, is a perspective view of an example of a longitudinal optical pumping device according to the prior art,

FIG. 1C, already described, is a perspective view of an example of an optical pumping device via the top face according to the prior art,

FIG. 2A is a front sectional view of an optical pumping device, according to the present invention, according to a first embodiment,

FIG. 2B is a top sectional view of the optical pumping device, according to the present invention, according to the first embodiment,

FIG. 3A is a front sectional view of an optical pumping device, according to the present invention, according to a second embodiment,

FIG. 3B is a top sectional view of an optical pumping device, according to the present invention, according to the second embodiment,

FIG. 4A is a front sectional view of an optical pumping device, according to the present invention, according to a third embodiment,

FIG. 4B is a front sectional view of an optical pumping device, according to the present invention, according to the third embodiment,

FIG. 4C is a front sectional view of an optical pumping device, according to the present invention, according to an alternative embodiment of the third embodiment,

FIG. 5 is a front sectional view of an optical pumping device, according to the present invention, according to a fourth embodiment,

FIG. 6 is a front sectional view of an optical pumping device, according to the present invention, according to a fifth embodiment,

FIG. 7A is a front sectional view of an optical pumping device, according to the present invention, according to a sixth embodiment,

FIG. 7B is a top sectional view of the optical pumping device, according to the present invention, according to the sixth embodiment,

FIG. 8 is a top sectional view of an optical pumping device, according to the present invention, according to a seventh embodiment.

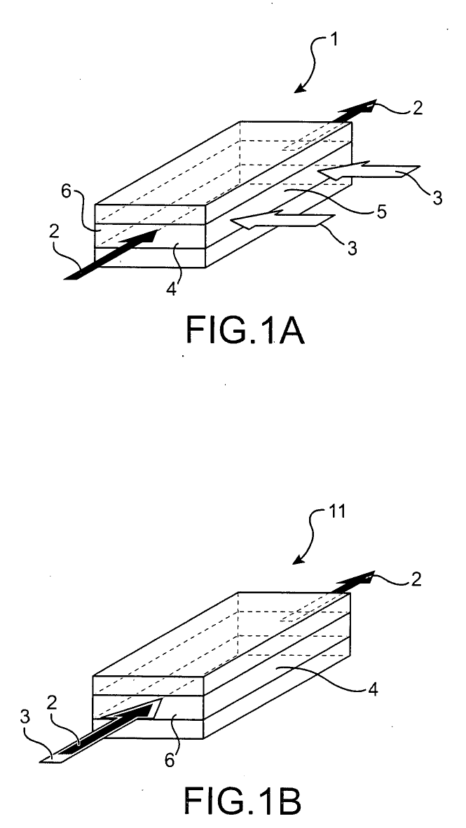

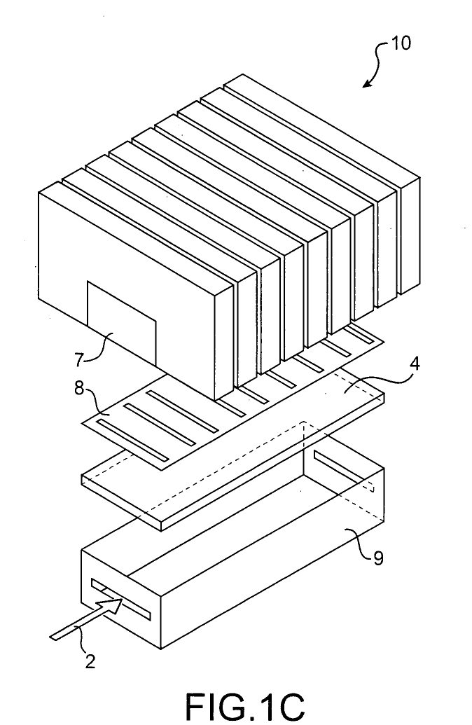

Identical, similar or equivalent parts of the various figures described hereinafter bear the same numeric references so as to facilitate the transition from one figure to another.

The various parts represented in the figures are not necessarily shown according to a uniform scale, in order to render the figures more legible.

The various possibilities (alternative embodiments and embodiments) should be understood as not being exclusive from each other and may be combined together.

### DETAILED DESCRIPTION OF SPECIFIC EMBODIMENTS

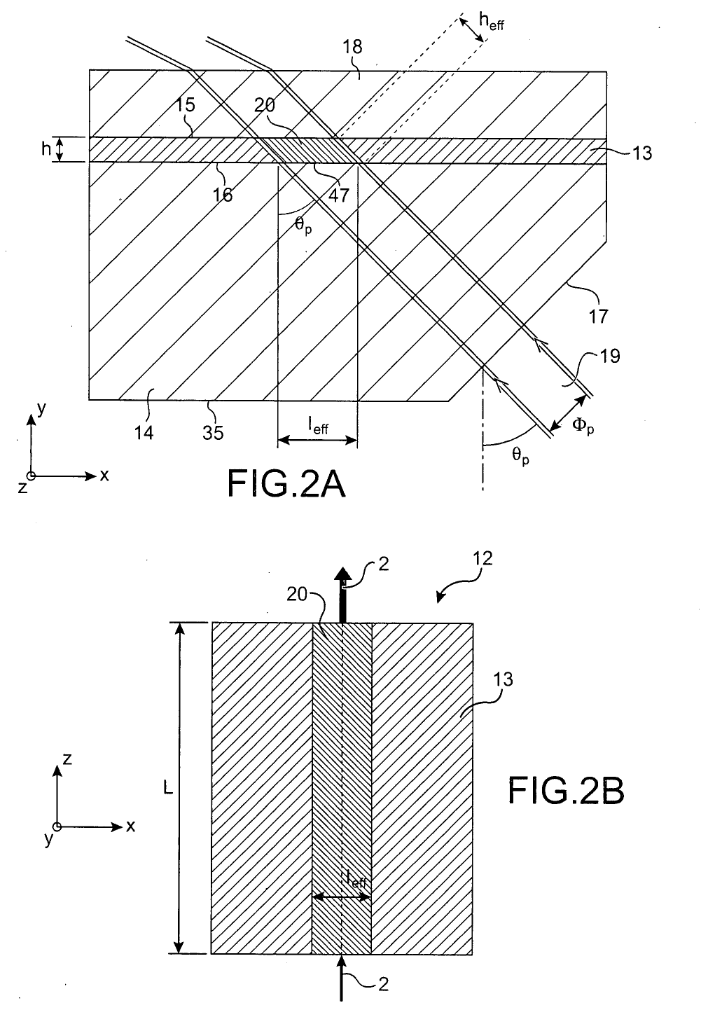

Reference will first be made to FIG. 2A and to FIG. 2B, which represent respectively a front sectional view and a top sectional view of an optical pumping device 12, according to the present invention, according to a first embodiment. This optical pumping device 12 comprises a layer 13 produced from an active material base doped with laser ions. In this example of an embodiment, this layer 13 is a thin layer, i.e. a layer in which the thickness is between approximately 1 micrometer and 50 micrometers or between 1 micrometer and 100 micrometers, monocrystalline, for example yttrium orthosilicate (YSO), doped with laser ions, in this case Yb³⁺ ytterbium ions. The Yb³⁺ ions, with a simple electronic structure, make it possible to prevent parasite effects occurring in high-power density optical pumping devices, such as that according to the present invention. According to the type of laser ions selected, the layer 13 may also be based on another other matrix displaying a reception site for said laser ions. This layer 13 has a given volume. In the examples of embodiments illustrated in FIGS. 2A to 8, the volume of the layer 13 is delimited by a first main face 16 and a second main face 15 that are substantially plane and parallel. An orthogonal reference xyz, consisting of three axes x, y, z, is represented in all the FIGS. 2A to 8. The plane xz, defined by the axes x and z, is substantially parallel with the main faces 15 and 16. The first main face 16 is arranged on a substrate 14. The layer 13 is for example obtained by means of Liquid Phase Epitaxis, a growth method used to obtain very good quality thin monocrystalline layers (a few dozen micrometers), i.e. having optical propagation losses less than 0.01 dB/cm, with very high doping, for example doped with approximately 40% active ions (laser ions), or more generally with a doping level greater than approximately 20% active ions or greater than approximately 30% active ions.

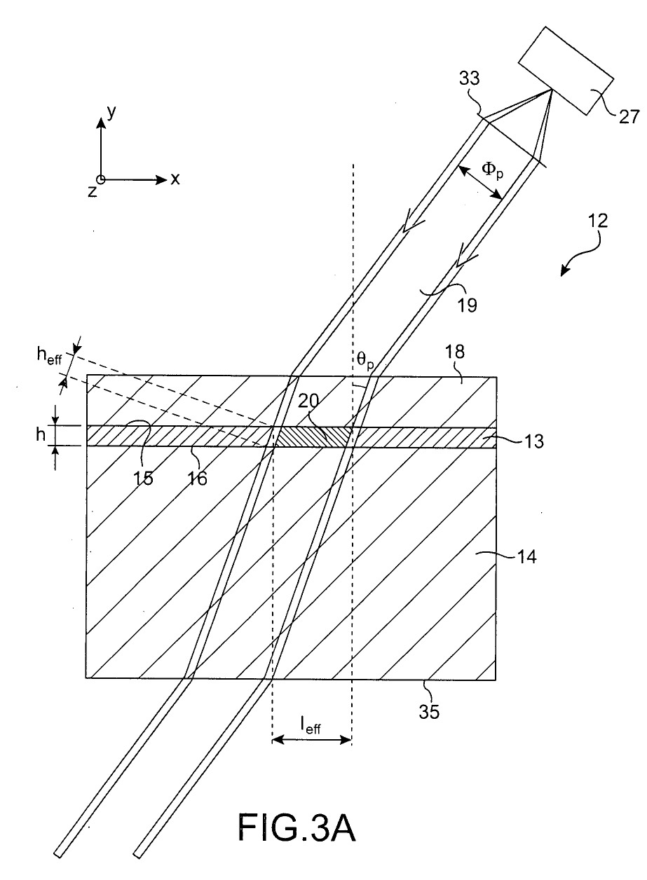

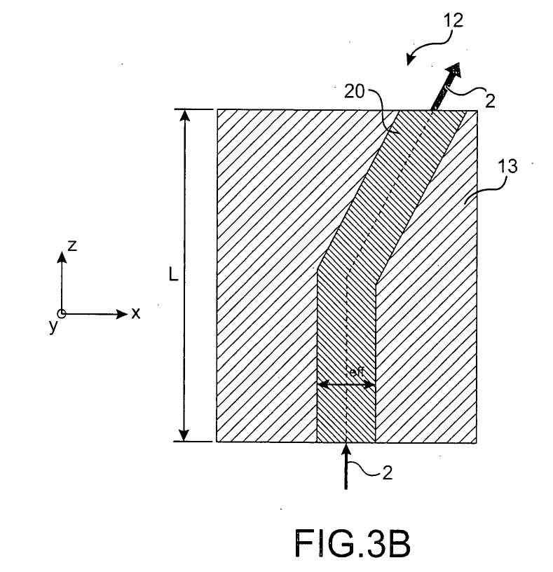

This optical pumping device 12 also comprises a pump beam 19. This pump beam 19 is a light beam wherein the wavelength is selected such that, when the photons of said pump beam 19 enter the layer 13, laser ions from said layer 13 change from a non-excited state to an excited state. This pump beam 19 is oriented such that it illuminates either the first main face 16 or the second main face 15. Advantageously, the illuminated face may be covered with an anti-reflection coating, not shown, produced for example by means of suitable dielectric multilayer depositions, thus making it possible to improve the output of the optical pumping device 12. In the example in FIGS. 2A and 2B, the first main face 16 is illuminated by the pump beam 19. The effective width of the pump beam 19 is indicated in FIG. 2A by Φp. The substrate 14 is in contact with the first main face 16 and is made of a material, in this case a monocrystal, that is transparent to the wavelength of the pump beam 19 such that the pump beam 19 arrives on the first main face 16 without any energy losses occurring in the substrate 14. The substrate 14 comprises a bevel 17. In FIG. 2A, the pump beam 19 enters the substrate 14 via the bevel 17. The bevel 17 is produced by cutting and polishing an edge of one base 35 of the substrate 14. In FIG. 2A, the pump beam 19 arrives with an angle of incidence of zero or almost zero on the bevel 17, which makes it possible to limit the reflection of the pump beam 19 when it enters the substrate 14. This substrate 14 makes it possible to evacuate the heat from the layer 13 in view of the confinement of the energy in said layer 13. In this embodiment, the pump beam 19 passes through the substrate 14 before entering the layer 13 via an entry point 47, which in this example is located on the first main face 16. The pump beam 19 arrives on the first main face 16 with an angle of incidence θp. The pump beam 19 illuminates the first main face 16 in a substantially rectilinear manner over the entire length L of the optical pumping device 12, parallel with the axis z, as can be seen in FIG. 2B. The pump beam 19 is emitted by a light source 27, represented in FIG. 3A, such as, for example, one or more laser diodes.

The pump beam 19 then passes through the layer 13 while changing laser ions from a non-excited state to an excited state. Due to this phenomenon, the energy of the pump beam 19 is transferred to the layer 13. The volume of the layer 13 passed through by the pump beam 19 absorbs the energy from the pump beam 19 and forms a zone referred to as the optical gain zone 20, visible in FIGS. 2A and 2B. It can be seen in FIG. 2B that, given that the pump beam 19 illuminates the first main face 16 in a substantially rectilinear manner, the optical gain zone 20 obtained is also substantially rectilinear over the entire length L of the optical pumping device 12. Therefore, in this embodiment, the pump beam 19 has a cross section of substantially rectangular shape and surface area substantially equal to Φp×L. Therefore, the energy of the pump beam 19 is concentrated in said optical gain zone 20. Given that the pump beam 19 arrives on the first main face 16 with an angle of incidence θp, therefore, the optical gain zone 20 has an effective thickness heff defined by equation (1) below:

heff=h/cos(θp) (1)

where h is the thickness of the layer 13.

This effective thickness heff corresponds to the distance traveled by the pump beam 19 in the layer 13. In this way, by varying θp, it is possible to control the proportion of power of the pump beam 19 absorbed in layer 13 in a simple manner.

Similarly, the effective width leff of the optical gain zone 20 is defined by equation (2) below:

leff=Φp/cos(θp) (2)

However, given that the optical gain zone 20 has, in this first embodiment, a substantially parallelepipedic volume V, this volume V is defined by the equation (3) below:

V=leff×h×L (3)

Therefore, it can be seen that the volume V of the optical gain zone 20 is adjustable by means of the dimensions Φp and L of the pump beam 19, therefore the cross section of the pump beam 19, and the angle of incidence θp of the pump beam 19 on the first main face 16. According to the present invention, the volume V is less than the total volume of the layer 13. In addition, the positioning of the optical gain zone 20, along the axis x parallel with the effective width leff, in the layer 13 is also adjustable with these parameters and with the entry point 47 of the pump beam 19 in the layer 13.

After passing through the layer 13, the pump beam 19 continues its trajectory and passes through a superstrate 18 arranged on the other face of the first main face 16 or the second main face 15 of the layer 13. In the example in FIGS. 2A and 2B, it consists of the second main face 15. This superstrate 18 may for example be made of the same material as the substrate 14, in this case, a monocrystal, transparent to the wavelength of the pump beam 19. This superstrate 18 may serve to extract heat produced by the pumping reaction in the layer 13, thus creating a temperature gradient along the axis y, parallel with the thickness h of the layer 13, making it possible to minimise the harmful thermal effects.

In the example of an embodiment in FIGS. 2A and 2B, the pump beam 19 passes through the substrate 14 from the bevel 17, and passes through the layer 13, and ends by passing through the superstrate 18. In an alternative embodiment of this embodiment, the pump beam 19 may pass through the substrate 14 without passing via the bevel 17, or the pump beam 19 first passes through the superstrate 18 and enters the layer 13 via the second main face 15, and finally passes through the substrate 14, as in FIG. 3A. In another alternative embodiment, there may not be a bevel 17 and/or superstrate 18 or even substrate 14. In this case, the pump beam 19 enters the layer 13 directly via the first or second main face 15 or 16 of the layer 13 with an angle of incidence Op without passing through anything beforehand.

The optical pumping device 12 according to the present invention is designed to amplify and guide a laser signal beam 2 visible in FIG. 2B. In this first embodiment, the optical pumping device 12 is firstly designed to amplify the laser signal beam 2. The laser signal beam 2 is sent to the entry of the layer 13, substantially parallel with the axis z, at the optical gain zone 20. While passing through the optical gain zone 20, as indicated with a dotted line in FIG. 2B, the laser signal beam 2 is amplified by retrieving the energy accumulated in the optical gain zone 20. The optical pumping device 12 also serves to guide the laser signal beam 2. In fact, in this example of an embodiment, it is assumed that the index of the material of the substrate 14 and the superstrate 18 is less than or equal to the index of the active material of the layer 13. The laser signal beam 2 sent to the layer 13 remains in said layer 13 and is not dispersed in the substrate 14 and the superstrate 18. Similarly, as the energy of the pump beam 19 is only located in the optical gain zone 20, the laser signal beam 2 remains confined in this optical gain zone 20 and is not dispersed throughout the layer 13 as the laser signal beam 2 is propagated preferentially in the zones with the highest gain. In this first embodiment, the effective width leff of the optical gain zone 20, substantially constant over the entire length L of the optical pumping device 12, is substantially equal to the width of the laser signal beam 2 and the thickness h is substantially equal to the height of the laser signal beam 2. Therefore, the dimensions of a cross section of the optical gain zone 20 are approximately equal to those of a cross section of the laser signal beam 2. Therefore, at the output of the optical pumping device 12, the laser signal beam 2 is obtained with the same quality as at the input of the optical pumping device 12. The quality of the laser signal beam refers to the spatial mode of the laser signal beam, which determines the divergence and dispersion of a spot of the laser signal beam. A laser beam is said to be of “good quality” if it displays a spatial energy distribution similar to that corresponding to the fundamental mode (determined by a cavity emitting the laser beam), which is, in the usual case of a cavity with revolution symmetry, a Gaussian mode. For example, if the laser signal beam 2 is monomode, entering the layer 13, it emerges from the optical pumping device 12 amplified and perfectly monomode. As a more general rule, this configuration makes it possible to simultaneously amplify a laser signal beam 2 in a fundamental spatial mode and retain said spatial mode until the output of the optical pumping device 12, by only supplying energy to the fundamental spatial mode.

For example, for a YSO layer 13 doped with 40% Yb³⁺ ions, of thickness h equal to 10 micrometers, wherein the lineic absorption coefficient at 978 nm is of the order of 200 cm⁻¹, a difference in index between the layer 13 and the substrate 14 being less than 0.01, 80% of the energy from a pump beam 19, wherein the width Φp is 10 micrometers and the angle of incidence θp is 7.2°, is absorbed to form an optical gain zone 20 making it possible to retain the monomode property during propagation in the direction of the axis z. The effective absorption thickness heff is in this case 80 micrometers, and therefore the optical gain zone 20 has a cross section equal to 10 micrometers*80 micrometers.

FIGS. 3A and 3B represent a second embodiment of an optical pumping device 12 according to the invention. A layer 13, a superstrate 18, a substrate 14, a pump beam 19 and an optical gain zone 20 of this second embodiment are substantially similar in nature to the same parts of the first embodiment. Compared to the first embodiment, the substrate 14 does not comprise a bevel. Unlike the pump beam 19 of the first embodiment, the pump beam 19 of the second embodiment is not rectilinear along a length L of the optical pumping device 12. As can be seen in FIG. 3A, the pump beam 19 enters the superstrate 18 and passes through the superstrate 18 before arriving on a second main face 15. A cross section of the pump beam 19 has a substantially similar shape to the top view of the optical gain zone 20, visible in FIG. 3B, but a width of the cross section of the pump beam 19 is Φp, unlike a width of the optical gain zone 20 which is leff. In this case, the pump beam 19 enters the layer 13 and forms an optical gain zone 20 which, as a result, does not have a rectilinear trajectory along the entire length L of the optical pumping device 12 along the axis z, as can be seen in FIG. 3B. In this second embodiment, the pump beam 19 is shaped, i.e. collimated, by an optical means 33. In FIG. 3A, said optical means 33 is a lens. Said optical means 33 could also be a prism. Said optical means 33 makes it possible to delimit the pump beam 19 precisely. As in the first embodiment, a laser signal beam 2 is amplified and guided in the optical gain zone 20. However, given that the laser signal beam 2 follows the optical gain zone 20 by means of the guidance by the gain generated by the energy density gradient, the optical pumping device 12 in this embodiment performs additional guidance due to the fact that the laser signal beam 2 follows a non-rectilinear trajectory. Therefore, the laser signal beam 2 emerges from the layer 13 oriented along an axis which is not parallel with that which the laser signal beam 2 had on entering the layer 13. This makes it possible to orient the laser signal beam 2 in a direction defined by the geometry of the pump beam 19. This phenomenon is reinforced by the Yb³⁺ ions used to dope the layer 13, as is the case in this embodiment. In fact, these ions absorb the laser signal beam 2 in the zones of the layer 13 in which the pump beam 19 does not pass through, which accentuates the guidance of the laser signal beam 2.

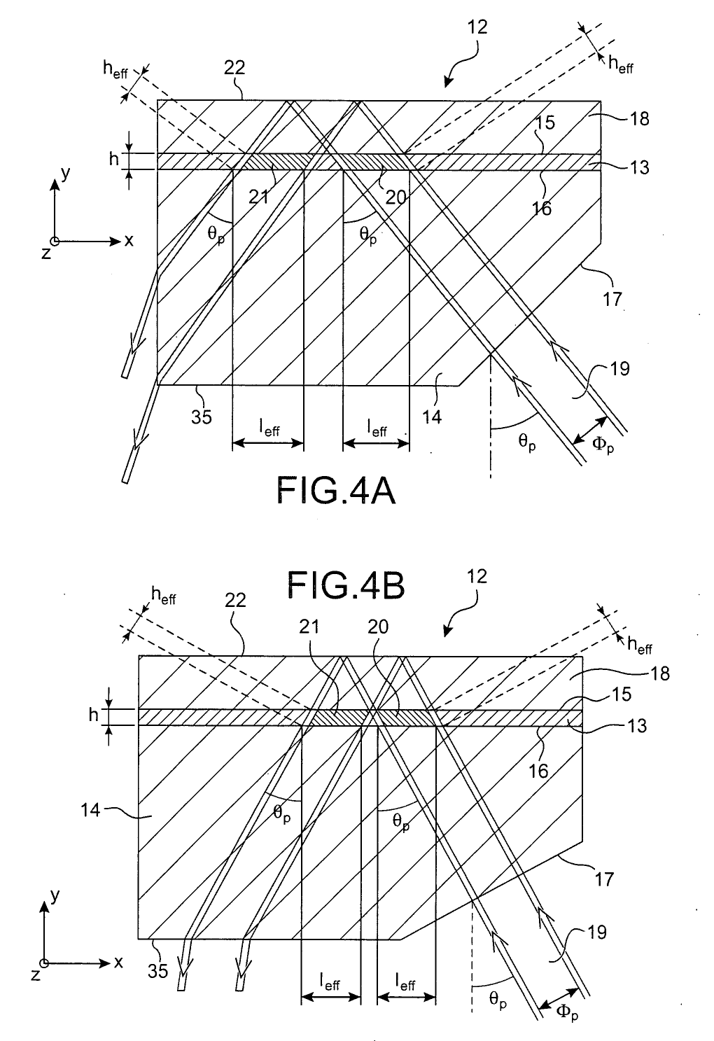

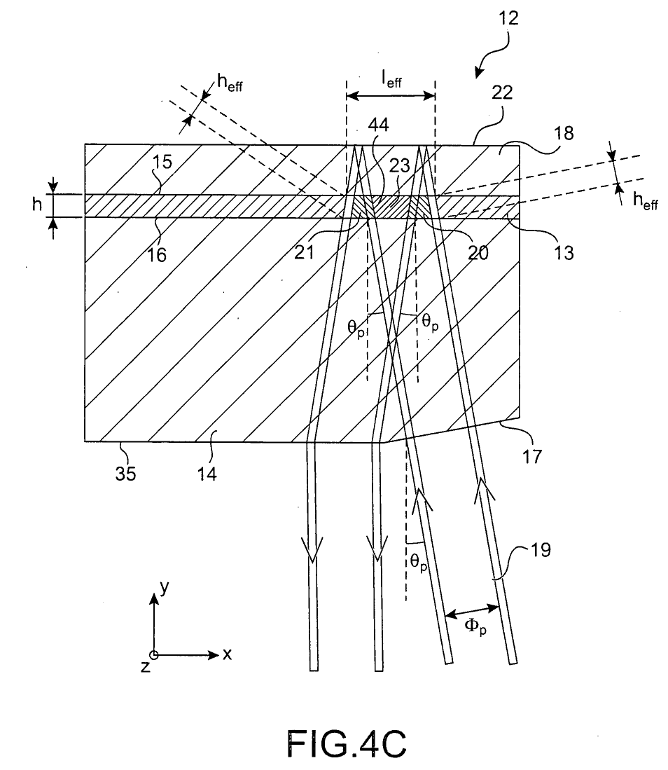

FIG. 4A represents a front sectional view of an optical pumping device 12, according to the present invention, according to a third embodiment. As in the first embodiment, the optical pumping device 12 comprises a layer 13, a superstrate 18, a substrate 14, a pump beam 19 and an optical gain zone 20. The difference of the optical pumping device 12 in this FIG. 4A with respect to that in FIG. 2A is that it comprises a reflective face 22 oriented towards the layer 13. This reflective face 22 is arranged on a face of the superstrate 18 substantially parallel with the first main face 16, the furthest from the layer 13. When the pump beam 19 passes through the layer 13, it forms, as in FIG. 2A, the optical gain zone 20, which is a first optical gain zone 20. The pump beam 19 then passes through the superstrate 18 to be reflected on the face 22. The pump beam 19 then passes again through the superstrate 18, and the layer 13 forming a second optical gain zone 21, of a volume substantially equal to the first optical gain zone 20. The second optical gain zone 21 may be parallel with the first optical gain zone 20 and have the same properties as those of the first optical gain zone 20. It is also defined by the same parameters, i.e. an orientation, an effective thickness heff, an effective width leff, a length and a thickness h of the layer 13. The pump beam 19 then passes through the substrate 14 and emerges from the substrate 14. In FIG. 4A, the second optical gain zone 21 is distinct and separated from the first optical gain zone 20. In this configuration, the pumping device 12 may amplify two laser signal beams, not shown in FIG. 4A, independently, each using either the first optical gain zone 20 of the second optical gain zone 21. Here again, the optical pumping device 12 fulfils the amplifying and optical guide function, as explained above. In another alternative embodiment, it is possible to have a pump beam 19 which is not rectilinear, as in the second embodiment. In this case, two non-rectilinear optical gain zones 20, 21 would be obtained. The pump beam 19 is emitted by a light source 27, represented in FIG. 3A. The pump beam 19 may also be shaped by an optical means 33, represented in FIG. 3A, as in the second embodiment. The various alternative embodiments presented for the first embodiment (presence or not of the bevel 17, substrate 14 and superstrate 18) may also be envisaged for this third embodiment.

FIG. 4B represents the optical pumping device 12, according to the present invention, according to the third embodiment. The optical pumping device 12 in this figure differs from that in FIG. 4A by the angle of incidence θp of the pump beam 19 on the layer 13. This angle of incidence θp is such that the optical gain zone 20 and the second optical gain zone 21 are distinct, but, unlike FIG. 4A where both optical gain zones 20, 21 were separated from each other, both optical gain zones 20, 21 are, in FIG. 4B, practically attached to each other.

Another alternative embodiment of this third embodiment is represented in FIG. 4C. In this figure, the optical pumping device 12 comprises the same components as the optical pumping device 12 in FIG. 4A. The difference is that the angle θp is such that the two optical gain zones 20 and 21 overlap to form a single optical gain zone 44. This overlapping results in the single optical gain zone 44 having an output density that is not uniform, unlike the previous embodiments. A zone 23, where the pump beam 19 intersects before and after the reflection on the face 22, located at the intersection of the optical gain zones 20, 21, in a central part of the single optical gain zone 44, has a greater power density at end parts of the single optical gain zone 44 located on either side of the central part corresponding to the intersection of the optical gain zones 20, 21. This alternative embodiment may make it possible to favour laser emission in a specific spatial mode by amplifying to the maximum the laser signal beam 2, not shown in FIG. 4C, only over a width defined by the width of the zone 23. This phenomenon is reinforced with doping of the layer 13 with Yb³⁺ ions, for which the “insufficiently pumped” zones, in this case, the end parts of the single optical gain zone 44 located outside the zone 23, absorb the laser signal beam 2.

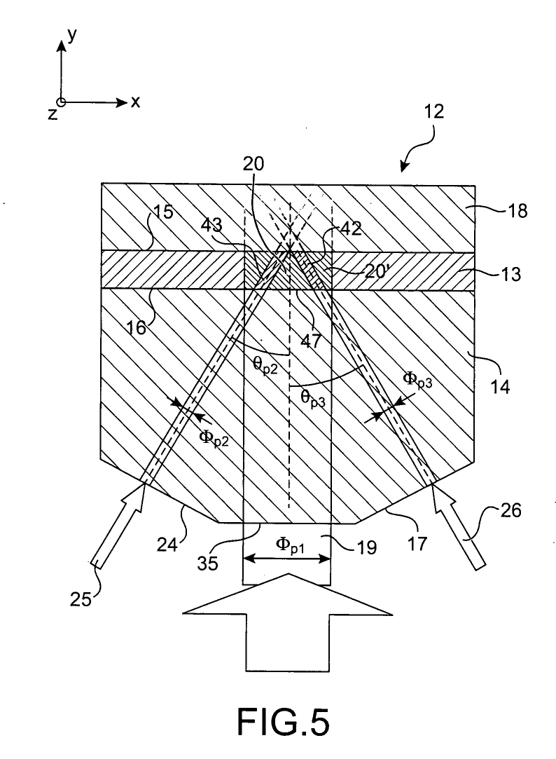

FIG. 5 represents a front sectional view of an optical pumping device 12, according to the present invention, according to a fourth embodiment. This optical pumping device 12 comprises a layer 13, a substrate 14 and a superstrate 18. Compared to the first embodiment, the substrate 14 comprises two bevels 17 and 24 produced on two opposite edges of a base 35. Unlike the previous embodiments, a so-called main pump beam 19, in FIG. 5 arrives, after passing through the substrate 14, on a first main face 16 with a zero angle of incidence θp1 (not shown) at an entry point 47. In FIG. 5, the optical pumping device 12 also comprises two other auxiliary pump beams 25, 26. These two auxiliary pump beams 25, 26 each enter via a bevel, 24 and 17 respectively, of the substrate 14. In this figure, each auxiliary pump beam 25, 26 arrives on the first main face 16 with an angle of incidence, θp2, θp3 respectively, for example substantially equal in absolute values, but of opposite signs. In another alternative embodiment, the auxiliary pump beams 25, 26 may have different angles of incidence θp2, θp3. After passing through the substrate 14, the three pump beams 19, 25, 26 form a common optical gain zone 20. In this figure, the pump beams 19, 25, 26 each have a different specific width Φp1, Φp2 and Φp3, and therefore a different cross section. The pump beams 19, 25, 26 may have different wavelengths to avoid saturating the absorption at a given wavelength. The pump beams 19, 25, 26 may also each have a different length, parallel with the axis z. By means of these pump beams 19, 25, 26 of different geometries, the common optical gain zone 20 has a power density which is not uniform. In FIG. 5, it can be seen that the common optical gain zone 20 comprises two regions 42, 43 where the main pump beam 19 and one of the auxiliary pump beams, 26 and 25, respectively, intersect. These two regions 42, 43 have a greater power density than the remainder 20′ of the common optical gain zone 20 which is only caused by the main pump beam 19. In this embodiment, each parameter, i.e. the entry point 47 in the layer 13, the angle of incidence θp1 and the width Φp1 of the main pump beam 19 form the common optical gain zone 20 and the similar parameters of the auxiliary pump beams 25, 26 help form the regions 42, 43. In this embodiment, the superstrate 18 is made of a material absorbent to the wavelength of the pump beams 19, 25, 26. In this way, after the pump beams 19, 25, 26 have passed through the layer 13, the residual intensity of these pump beams 19, 25, 26 is absorbed in the superstrate 18. This embodiment makes it possible, for example, to favour laser emission in a given spatial mode, or create several distinct guides in the common optical gain zone 20. With this embodiment, one or more laser signal beams 2, not shown in FIG. 5, may enter via the layer 13 and, according to their respective position in the common optical gain zone 20, pass through the layer 13 and emerge from the optical pumping device 12 with a spatial mode which will be determined by the point where they entered the common optical gain zone 20 and therefore by the power density encountered. In this fourth embodiment, several alternative embodiments are possible. The pump beams 19, 25, 26 may, for example, be rectilinear or not. Alternative embodiments may be envisaged by adding additional pump beams. The optical pumping device 12 may also have a reflective face 22 as in the third embodiment, making it possible to obtain an even more complex geometry in the optical gain zone 20. As in the first embodiment, alternative embodiments may be envisaged with the presence or not of bevels 17 and 24, of the substrate 14, or the elimination of the superstrate 18.

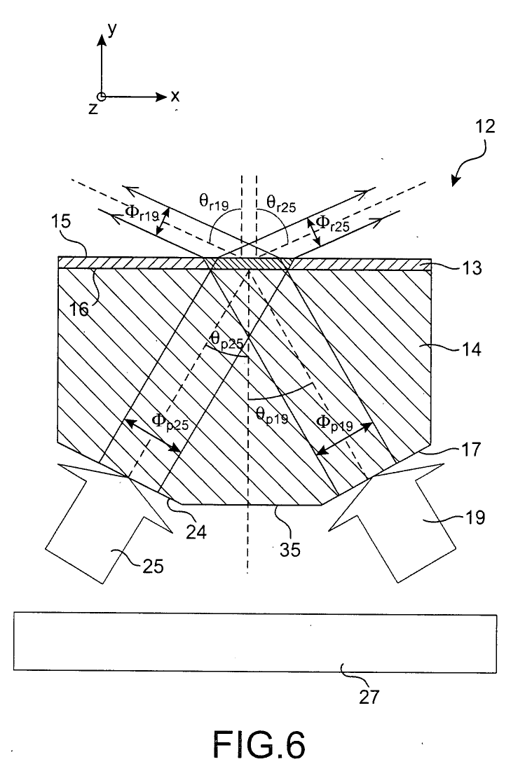

FIG. 6 represents a front sectional view of an optical pumping device 12, according to the present invention, according to a fifth embodiment. This optical pumping device 12 comprises a layer 13 and a substrate 14 substantially similar to those of the fourth embodiment. In this fifth embodiment, at least two pump beams 19, 25 are generated from a common light source 27. In FIG. 6, two pump beams 19,25 are represented. The pump beams 19, 25 each have an angle of incidence θp19 and θp25, for example substantially equal in absolute values but of opposite signs, on a first main face 16, a width Φp19 and Φp25 that are substantially equal and intersect in the layer 13 so as to form a single optical gain zone 20. Given that the pump beams 19, 25 are from the same light source 27, that they are substantially equal and that they illuminate the face 16 with substantially equal angles of incidence θp19 and θp25, there is therefore interference between the two pump beams 19, 25 in the single optical gain zone 20, which induces a pump power density varying in a sinusoidal manner along the axis x. The period of this sinusoidal variation is adjustable by modifying the angles of incidence θp19 and Φp25, and the widths Φp19 and Φp25 of each of the pump beams 19, 25. The pump beams 19, 25 emerge from the layer 13 with angles of refraction θr19 and θr25 that are substantially equal in absolute values with respect to a second main face 15 and each have a substantially equal width Φr19 and Φr25. With this embodiment, it is thus possible to create a family of parallel optical guides, pumped identically or almost identically. The alternative embodiments described for the previous embodiments may also be applied for this fifth embodiment.

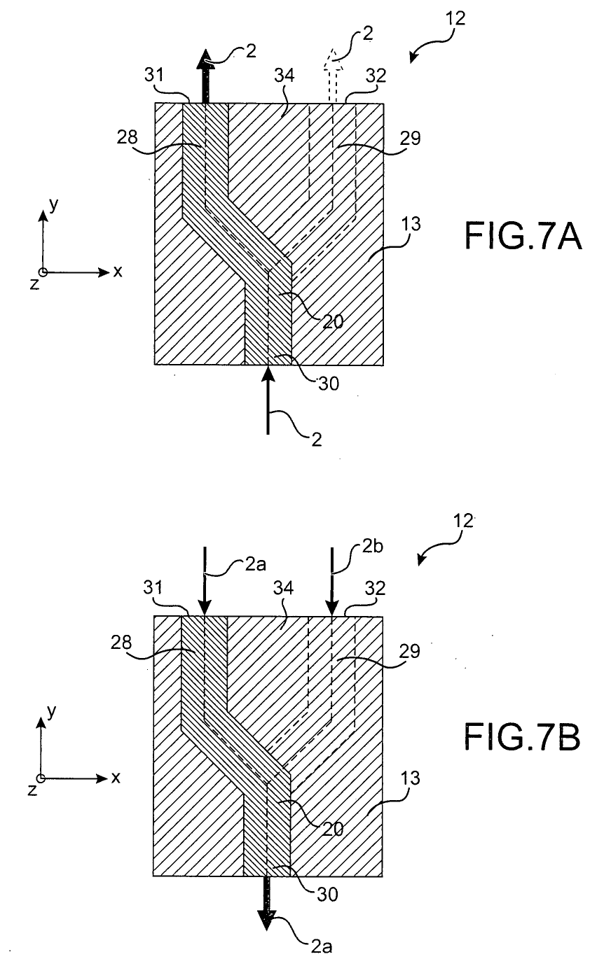

FIG. 7A represents a top sectional view of an optical pumping device 12, according to the present invention, according to a sixth embodiment. This optical pumping device 12 comprises a layer 13 and a substrate 14 not shown in FIG. 7A, substantially similar to those of the first embodiment. In this sixth embodiment, a pump beam 19, not shown in FIG. 7A, enters via the substrate 14 and forms in the layer 13 an optical gain zone 20. In this embodiment, the optical gain zone 20 is divided into two first parts 28, 29, separated from each other by a non-illuminated zone 34 of the layer 13, which are extended by a second common part 30. This second common part 30 connects the first two parts 28, 29. During the operation of the pumping device 12, a light source 27, not shown in this FIG. 7, emits the pump beam 19 which forms the optical gain zone 20. However, during the operation of the pumping device 12, the pump beam 19 is such that it forms one of the two first parts 28 and the second common part 30, as is the case in FIG. 7A, or it forms the other of the two first parts 29 and the second common part 30. In this way, the light source 27 may indifferently create two different optical paths in the layer 13. In this way, a laser signal beam 2 entering the layer 13 via the second part 30 may either be guided in a first optical path defined by one of the two first parts 28, represented as a solid line in FIG. 7A, and therefore emerge from the layer 13 via a first end 31 which is an output, as is the case in FIG. 7A, or guided in a second optical path defined by the other of the two first parts 29, represented as a dotted line in FIG. 7A, and therefore emerge from the layer 13 via a second end 32 which is also an output, located next to the first end 31. The optical pumping device 12 thus performs an optical routing function making it possible to route the laser signal beam 2 along two trajectories, indifferently. With the same configuration, it is also possible to envisage that the optical pumping device 12 performs an optical switching function, as represented in FIG. 7B. For this, two laser signal beams 2a, 2b arrive at both ends 31 and 32 respectively, which become inputs in this case. If the pump beam 19, not shown in FIG. 7B, illuminates one of the two first parts 28, represented as a solid line in FIG. 7B, and the second common part 30, only the laser signal beam 2a entering via the first end 31 emerges from the optical pumping device 12 amplified, as is the case in FIG. 7B. Similarly, if the pump beam 19 illuminates the other of the two first parts 29, represented as a dotted line in FIG. 7B, and the second common part 30, only the laser signal beam 2b entering via the second end 32 emerges amplified from the optical pumping device 12. All the alternative embodiments described above may also be applied in this sixth embodiment.

In all the embodiments described above, the optical pumping device 12 is used as an amplifier and optical guide for one or more existing laser signal beams 2. The laser signal beam 2 enters a layer 13 of an active material, passes through the layer 13 while amplifying the energy supplied by a pump beam 19 in an optical gain zone 20 and along this optical gain zone 20, and emerges from the optical pumping device 12.

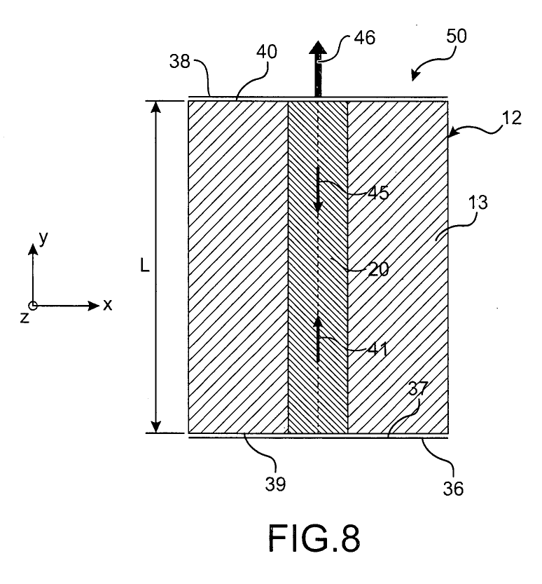

The present invention also relates to a laser oscillator 50. The laser oscillator 50 is designed to create a laser beam. The principle of this laser oscillator is that an optical pumping device is arranged between two mirrors. One of the two mirrors returns the laser beam to the optical gain zone, and the other of the two mirrors returns part of the laser beam to the optical gain zone and allows another part to pass outside the optical pumping device. The optical pumping device is thus used as a gain module of the laser oscillator 50. FIG. 8 represents an example of a laser oscillator 50, according to the present invention. The laser oscillator 50 comprises an optical pumping device 12, also according to the present invention, according to any of the above embodiments. The optical pumping device 12 comprises a substrate, a pump beam, a superstrate, not shown in FIG. 8, a layer 13 and an optical gain zone 20 substantially similar to the same components of the first embodiment of the optical pumping device 12. The laser oscillator 50 comprises a first mirror 36 wherein one reflective face 37 is arranged against a third face 39 of the layer 13, substantially perpendicular to the main faces of the layer 13. The laser oscillator 50 also comprises a second semi-transparent mirror 38, arranged against a fourth face 40, opposite the third face 39, of the layer 13. In this example of an embodiment, the mirrors 36 and 38 are arranged substantially facing each other. With this laser oscillator 50, a laser beam 41, generated by spontaneous and amplified emission by means of stimulated emission in the optical gain zone 20, will firstly passes through the layer 13, be reflected in the second mirror 38, pass through the layer 13 again, be reflected in the first mirror 36, and so on. Each time it pass through the layer 13 and therefore the optical gain zone 20, the laser beam 41 recovers the energy supplied by the pump beam in the optical gain zone 20. Each time the laser beam 41 reaches the semi-transparent mirror 38, a part 45 of the laser beam 41 is reflected by the semi-transparent mirror 38 in the optical gain zone 20 and another part 46 of the laser beam 41 emerges from the optical pumping device 12, passing through the semi-transparent mirror 38.

This description of the laser oscillator 50 is one of the possible embodiments. Given that the principle of the laser oscillator 50 is based on the positioning of the two mirrors 36, 38 on either side of the layer 13, any of the optical pumping devices 12 described above in the present disclosure may be used to produce a gain module of the laser oscillator 50 such as that in FIG. 8.

In an alternative embodiment, the mirrors 36,38 may not be attached to the optical pumping device 12. At least one of the two mirrors may also not be plane, but concave, to reinforce the stability of the laser oscillator 50.

Although several embodiments of the present invention have been described in detail, it will be understood that various changes and modifications may be made without leaving the scope of the invention.

1. Optical pumping device, comprising at least one thin layer designed to guide and amplify at least one monomode laser signal beam such that said beam remains monomode after passing through the layer, said layer having a given volume, and being produced on an active material base doped with laser ions, the device also comprising at least one pump beam having a cross section of given dimensions, of a wavelength selected to be able to place the laser ions of the active material in an excited state, entering at an entry point in the layers with a given angle of incidence, forming at least one optical gain zone in the layer, the optical gain zone having an adjustable volume and positioning in the layer by means of the entry point, to the dimensions of the cross section of the pump beam and the angle of incidence, the entry point, the volume of the optical gain zone being less than the volume of the layer the optical gain of said zone being optimized by an appropriate choice of the entry point, the dimensions of the cross section of the pump beam and the angle of incidence.

2. Optical pumping device according to claim 1, angle of incidence being not equal to zero with respect to a perpendicular to the plane of the layer.

3. Optical pumping device according to claim 1, the thin layer having a thickness approximately 1 micrometer and 10 micrometers.

4. Optical pumping device according to claim 1, the thin layer having a thickness of less than approximately 100 micrometers.

5. Optical pumping device according to claim 1, the thin layer having a thickness of less than approximately 50 micrometers.

6. Optical pumping device according to claim 1, the thin layer being doped with a doping level of approximately 40% laser ions.

7. Optical pumping device according to claim 1, the thin layer being doped with a doping level greater than approximately 30% laser ions.

8. Optical pumping device according to claim 1, the thin layer being doped with a doping level greater than approximately 20% laser ions.

9. Optical pumping device according to claim 1, the laser ions being ytterbium ions.

10. Optical pumping device according to claim 1, the layer being monocrystalline.

11. Optical pumping device according to claim 1, the layer being based on yttrium orthosilicate or any other matrix displaying a reception site for laser ions.

12. Optical pumping device according to claim 1, the pump beam being emitted by at least one light source, such as at least one laser diode.

13. Optical pumping device according to claim 1, the pump beam being shaped by at least one optical means, such as a lens or a prism, before entering the layer so as to delimit the pump beam.

14. Optical pumping device according to claim 1 the optical gain zone defining the layer, for the laser signal beam, a rectilinear trajectory.

15. Optical pumping device according to claim 1, the optical gain zone defining the layer, for the laser signal beam, a non-rectilinear trajectory.

16. Optical pumping device according to claim 1, the dimensions of a cross section of the optical gain zone being approximately equal to those of a cross section of the laser signal beam.

17. Optical pumping device according to claim 1, the layer being arranged on at least one substrate.

18. Optical pumping device according to claim 17, the substrate being made of a material transparent to the wavelength of the pump beam.

19. Optical pumping device according to claim 17, the index of the material of the substrate being less than or equal to the index of the material of the layer.

20. Optical pumping device according to claim 17, the pump beam passing through the substrate before entering the layer.

21. Optical pumping device according to claim 17, the substrate comprising at least one bevel.

22. Optical pumping device according to claim 21, the pump beam entering the substrate via the bevel and passing through the substrate before entering the layer.

23. Optical pumping device according to claim 17, comprising at least one superstrate arranged on the layer.

24. Optical pumping device according to claim 23, the index of the material of the superstrate being less than or equal to the index of the material of the layer.

25. Optical pumping device according to claim 23, the superstrate being made of a material transparent to the wavelength of the pump beam.

26. Optical pumping device according to claim 23, 23 to 25, the pump beam passing through the superstrate before entering the layer.

27. Optical pumping device according to claim 23, the superstrate being made of a material absorbent to the wavelength of the pump beam.

28. Optical pumping device according to claim 23, comprising at least one reflective face oriented towards the layer.

29. Optical pumping device according to claim 28, the pump beam being reflected onto the reflective face and forming in the layer at least one second optical gain zone distinct from the optical gain zone, the second optical gain zone being separated or practically attached to the optical gain zone.

30. Optical pumping device according to claim 28, the pump beam being reflected on the reflective face and forming at least one second optical gain zone overlapping with the optical gain zone, thus creating a single optical gain zone.

31. Optical pumping device according to claim 1, several pump beams intersecting in the layer, the pump beams cooperating to form the optical gain zone.

32. Optical pumping device according to claim 31, the pump beams having different wavelengths.

33. Optical pumping device according to claim 1, comprising at least two pump beams, from a common light source, each having an angle of incidence on the layer, interfering in the layer, the optical gain zone formed by the two pump beams having a pump power density varying in a sinusoidal manner.

34. Optical pumping device according to claim 1, the optical gain zone being divided into at least two first parts separated from each other by at least one non-illuminated zone of the layer, and into at least one second common part connecting the two first parts.

35. Optical pumping device according to claim 1, the volume of the layer being delimited by a first and a second substantially plane main faces.

36. Optical pumping device according to claim 35, the first and the second main faces being substantially parallel.

37. Laser oscillator, designed to generate a laser beam, comprising at least two mirrors, an optical pumping device according to claim 1, the two mirrors being attached or not to the optical pumping device, one of the two mirrors being designed to return the laser beam in the optical gain zone, and the other of the two mirrors being designed to return a part of the laser beam in the optical gain zone and to allow another part to pass outside the optical pumping device, the optical pumping device being a gain module of the laser oscillator.

38. Laser oscillator according to claim 37, the volume of the layer of the optical pumping device being delimited by a first and a second substantially plane and parallel main faces, one of the two mirrors having a reflective face arranged against a third face of the layer, substantially perpendicular to the two main faces, and the other of the two mirrors being a semi-transparent mirror, substantially parallel with the first mirror and arranged against a fourth face, opposite the third face, of the layer.
